(19) United States
(12) Patent Application Publication
(10) Pub. No.: US 2025/0184217 A1
(43) Pub. Date: Jun. 5, 2025

(54) COMMUNICATION APPARATUS

(71) Applicant: BROTHER KOGYO KABUSHIKI KAISHA, Nagoya (JP)

(72) Inventor: Ayako SUGIYAMA, Okazaki (JP)

(21) Appl. No.: 18/960,108

(22) Filed: Nov. 26, 2024

(30) Foreign Application Priority Data
Nov. 30, 2023 (JP) 2023-203367

(51) Int. Cl. H04L 41/0806; H04L 67/51

(52) U.S. Cl. CPC H04L 41/0806; H04L 67/51

(57) ABSTRACT

A communication apparatus includes a communication interface, a notifying device, and a controller. The controller is configured to, in response to power supply to the communication apparatus, determine whether an initial-setting process in the communication apparatus is completed, and in response to determining that the initial-setting process is incomplete, control the notifying device to perform a first notification that prompts execution of the initial-setting process using an external terminal.

### REFERENCE TO RELATED APPLICATIONS

This application claims priority from Japanese Patent Application No. 2023-203367, filed on Nov. 30, 2023. The entire content of the priority application is incorporated herein by reference.

### BACKGROUND ART

A setup assisting method to assist a user to set up a computer so that the computer is enabled to work in cooperation with an external device is known. According to the setup assisting method, the computer may be driven to execute a setup guiding program stored in a CD-ROM set in a CD-ROM drive of the computer. By executing the setup guiding program, guidance information showing a setup procedure may be displayed to the user through a display device. A controller in the computer may update values of flags stored in a hard disk drive as the setup procedure progresses. Later, when the computer executes the setup guiding program again, the controller may display the guidance information according to the updated values of the flags stored in the hard disk drive.

### SUMMARY

Meanwhile, initial settings of a communication apparatus may be processed by an external terminal, such as a PC. However, operations for the setup using the external terminal may be a burden to the user, as the user may need to operate the PC to execute a setup guiding program for the communication apparatus stored in a CD-ROM set in a CD-ROM drive in the PC.

The present disclosure relates to a communication apparatus that may be setup using an external terminal easily.

According to an aspect of the present disclosure, a communication apparatus includes a communication interface, a notifying device, and a controller. The controller is configured to, in response to power supply to the communication apparatus, determine whether an initial-setting process in the communication apparatus is completed, and in response to determining that the controller determines the initial-setting process is incomplete, control the notifying device to perform a first notification that prompts execution of the initial-setting process using an external terminal.

### BRIEF DESCRIPTION OF DRAWINGS

FIG. 1 is a block diagram to illustrate an overall configuration of a communication system.

FIGS. 2A-2B are a flowchart illustrating steps in a powered-on process to be executed by a CPU in an MFP within the communication system.

FIGS. 3A-3D illustrate screens to be displayed on an LCD of the MFP.

FIGS. 4A-4B illustrate screens to be displayed on the LCD of the MFP.

FIGS. 5A-5C illustrate screens to be displayed on an LCD of a mobile terminal in the communication system.

FIGS. 6A-6C illustrate screens to be displayed on a non-touch sensitive display-only LCD.

FIG. 7 illustrates screens to be displayed on an LCD capable of displaying a single text line.

FIGS. 8A-8B illustrate combinations of lighting patterns of an indicator consisting of LEDs.

### DESCRIPTION

Hereinbelow, embodiments of the present disclosure will be described in detail.

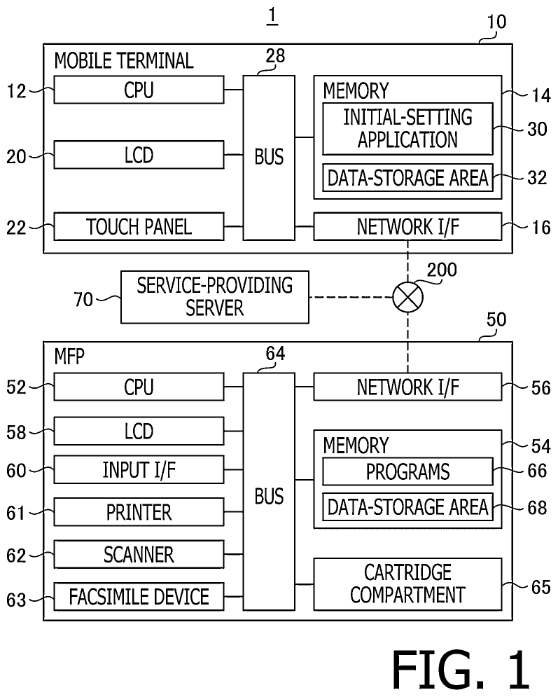

FIG. 1 is a block diagram to illustrate an overall configuration of a communication system 1 according to an embodiment of the present disclosure. As shown in FIG. 1, the communication system 1 includes a mobile terminal 10 being an example of the external terminal, an MFP 50 being an example of the communication apparatus, and a service-providing server 70. The term MFP is an abbreviation of Multi-Function Peripheral machine.

The mobile terminal 10 and the MFP 50 are connected to a network 200. The network 200 may be any of the Internet, a local area network (LAN), and a combination of the Internet and LAN. The network 200 may be a wired network, a wireless network, or a combination of wired and wireless networks. In the present embodiment, the mobile terminal 10 and the MFP 50 are connected wirelessly through a router (not shown), which composes a part of the network 200. Moreover, the service-providing server 70 is connected to the network 200.

The mobile terminal 10 includes a CPU 12, a memory 14, a network interface (I/F) 16, an LCD 20, and a touch panel 22, which are connected to communicate with one another through a bus 28. The mobile terminal 10 may be, but not necessarily, for example, a smartphone. For another example, the mobile terminal 10 may be a tablet device or a laptop computer. The configuration of the mobile terminal 10 shown in FIG. 1 is merely an example. Optionally, the mobile terminal 10 may include a mobile communication I/F for communicating wirelessly with a mobile base station and a camera for capturing images.

The CPU 12 is configured to execute a process for initial settings of the mobile terminal 10 according to an initial-setting application 30 stored in the memory 14. The initial-setting application 30 may not initially be stored in the memory 14 of the mobile terminal 10 but may be downloaded from, for example, the service-providing server 70 and installed in the mobile terminal 10 to be executed. The CPU 12 may execute the initial-setting application 30 to set a password for an administrator of the MFP 50, set time in the MFP 50, and control the LCD 20 to display guidance for the initial settings. In the description below, the CPU 12 to execute the initial-setting application 30 may be represented by a name of the application program to be executed. For example, a phrase such as “the initial-setting application 30 controls” may equate to “the CPU 12 executing the initial-setting application 30 controls.”

The memory 14 includes a data-storage area 32. The data-storage area 32 is an area to store data that may be necessary for the CPU 12 to execute the initial-setting application 30.

The network I/F 16 is a communication interface enabling wired or wireless communication with the network I/F 56 of the MFP 50 connected to the network 200. The network I/F 16 includes chips and circuits that comply with the communication standards of the wired or wireless LAN. The mobile terminal 10 and the MFP 50 may exchange electric data through, for example, Wi-Fi. Wi-Fi is a networking technology of wireless LAN and is a registered trademark of Wi-Fi Alliance. However, the communication method between the mobile terminal 10 and the MFP 50 is not necessarily limited. For example, the mobile terminal 10 and the MFP 50 may communicate wirelessly through Bluetooth or NFC. Bluetooth is a registered trademark of Bluetooth SIG, Inc., and NFC is a registered trademark of NFC Forum, Inc.

The LCD 20 includes a display screen, on which functions of the mobile terminal 10 may be displayed. The touch panel 22 includes touch sensors, which are arrayed to cover the display screen of the LCD 20. The touch panel 22 may detect approaching or contacting behaviors of a user's fingers or a touch-pen and output electrical signals according to the detected behaviors.

Meanwhile, the MFP 50 includes a CPU 52, a memory 54, a network I/F 56, an LCD 58, an input I/F 60, a printer 61, a scanner 62, a facsimile device 63, and a cartridge compartment 65, which are connected to communicate with one another through a bus 64.

The CPU 52 executes processes in accordance with programs 66 stored in the memory 54. The programs 66 include, for example, application programs to execute a printing process and a scanning process and application programs to initially set the MFP 50 according to commands from the initial-setting application 30 in the mobile terminal 10. The memory 54 includes a data-storage area 68, which is an area to store data necessary for the CPU 52 to execute the programs 66.

The memory 14 in the mobile terminal 10 is composed of RAM, ROM, flash memory, HDD, and a buffer in the CPU 12. The memory 54 in the MFP 50 is composed of RAM, ROM, flash memory, HDD, and a buffer in the CPU 52. The memory 54 in the MFP 50 and the memory 14 in the mobile terminal 10 may be the computer-readable storage medium storing information readable by the CPU 52 and the CPU 12, respectively. The storage medium storing information readable by the CPU 52 and the CPU 12 is a non-transitory medium, which is a tangible medium. The non-transitory medium may include storage medium such as, for example, CD-ROM and DVD-ROM. Meanwhile, electrical signals conveying a program downloadable through the Internet, for example, from a server, may form a computer-readable signal medium but may not form a non-transitory computer-readable storage medium.

The network I/F 56 of the MFP 50 is a communication interface enabling wired or wireless communication with the network I/F 16 of the mobile terminal 10 and includes chips and circuits that comply with the communication standards of the wired or wireless LAN.

The LCD 58 includes a display screen, on which functions of the MFP 50 may be displayed. The input I/F 60 is a touch panel formed integrally with the LCD 58 and may receive input from a user operating icons or buttons displayed on the display screen of the LCD 58. Additionally or alternatively to the touch panel, the input I/F 60 may include hardware keys.

The printer 61 may form an image on a sheet, e.g., a paper sheet or an OHP film. The printer 61 may be an electro-photographic printer including an exposure unit, a photosensitive member, a developing roller, and a fuser. The printer 61 may be an inkjet printer including an inkjet head, a carriage, and a carriage-driving device. The MFP 50 may receive a print command from the mobile terminal 10 and operate the printer 61 to print an image based on printable image data included in the received print command. The scanner 62 includes a reading sensor that may read an image on an original material. The MFP 50 may receive a scan command from the mobile terminal 10, generate scan data composing the image having been read with the scanner 62, and transmit the generated scan data to the mobile terminal 10. The facsimile device 63 may perform a facsimile transmitting/receiving process according to a predetermined protocol.

The cartridge compartment 65 is formed to accommodate a cartridge storing a colorant, such as ink or toner that may color the sheet. The cartridge compartment 65 includes a detection sensor, which may detect the cartridge being attached to the cartridge compartment 65. Alternatively, the MFP 50 may have a tank to store the colorant in place of the cartridge compartment 65. The tank may have an inlet, and the user may pour the colorant from a bottle through the inlet to load the tank with the colorant. Moreover, the tank may include a detection sensor, which may detect whether an amount of the colorant stored in the tank is greater than a predetermined threshold amount.

The service-providing server 70 includes a CPU, a memory, a network I/F, an LCD, and an input I/F, which may operate substantially similarly to those in the mobile terminal 10 or the MFP 50. The service-providing server 70 may provide various types of services, such as a remote-printing function, using a communication apparatus including the MFP 50, to the user of the communication apparatus. The remote-printing function is a function that enables the MFP 50 to print an image based on printable data received from a terminal device connected to the network 200 through the service-providing server 70. The service-providing server 70 may, as explained earlier, store the initial-setting application 30 therein and transmit the initial-setting application 30 in response to a request from the mobile terminal 10. However, the initial-setting application 30 may not necessarily be stored in the service-providing server 70 but may be stored in a different server, and the mobile terminal 10 may access the different server and download the initial-setting application 30 therefrom.

The embodiment described in the paragraphs below will explain processes to be executed by the CPUs 12, 52 according to instructions described in the programs. In the explanation, terms to express acts in the mobile terminal 10, the MFP 50, and the service-providing server 70 such as selecting, determining, specifying, obtaining, receiving, and controlling may represent processes executed by the CPUs, or controllers. The processes to be executed by the CPUs include controlling over hardware devices through OSes. Meanwhile, an act of obtaining may not necessarily be induced by an act of requesting. In other words, the CPUs may receive data without requesting, and the act of receiving may still be expressed as “the CPU obtains the data.” Moreover, a term “data” in the present disclosure may mean a bit string readable by a computer. Data units containing substantially the same contents but in different formats may be regarded as a same data unit, and a term “information” may be regarded similarly.

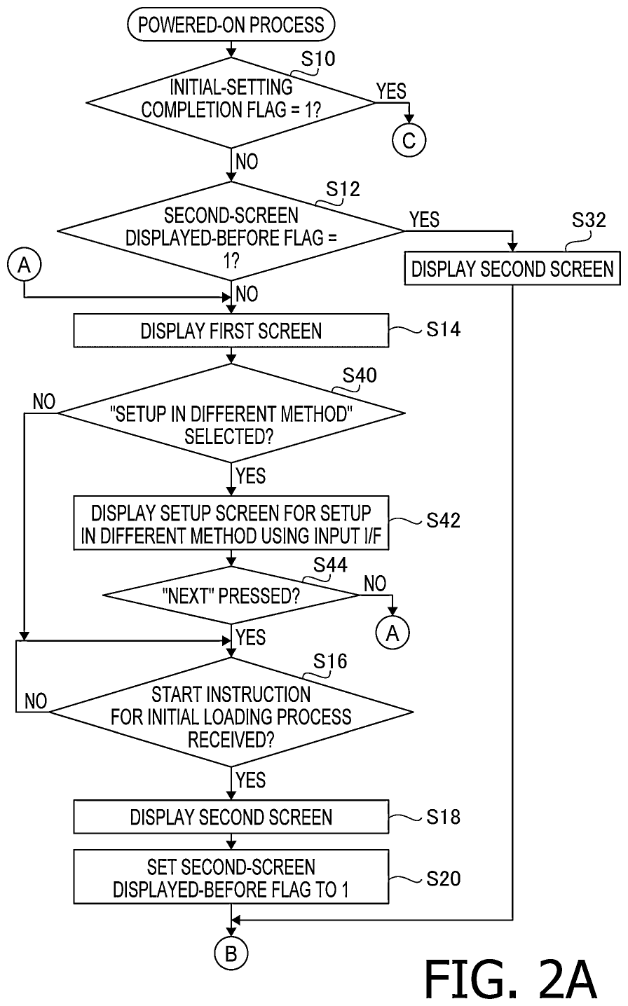

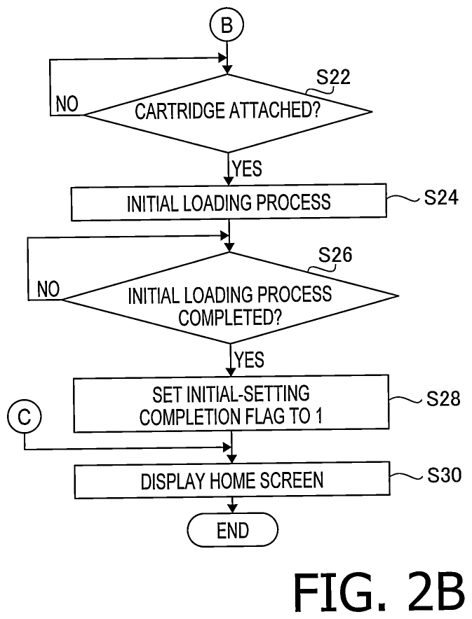

The controlling processes to be executed in the communication system 1 as configured above is described below with reference to FIGS. 2-5.

FIGS. 2A-2B are a flowchart illustrating steps in a powered-on process to be executed by the CPU 52 in the MFP 50 within the communication system 1. The powered-on process starts in response to power being supplied to the MFP 50 based on input of an instruction for power supply to the MFP 50. The instruction for power supply to the MFP 50 may be input by, for example, a power switch being operated while the MFP 50 is not powered or by the touch panel being operated or data being received through the network I/F 56 while the MFP 50 is in a sleep mode. In the description below, steps in the processes will be referred to with a sign “S.”

In response to the power supply to the MFP 50, the powered-on process starts, and the CPU 52 determines whether an initial-setting completion flag stored in the data-storage area 68 in the memory 54 is set to 1 (S10). The initial-setting completion flag is set to 1 when an initial-setting process in the MFP 50 is completed, and an initial value thereof is 0 (zero).

The initial-setting process in the MFP 50 in the present embodiment includes, for example, a password-setting process to set a password for an administrator of the MFP 50, a time-setting process, and an initial loading process in which the printer 61 is loaded with ink or toner. However, the initial-setting process may not be limited to these three processes but may include one or two of these processes, or another process(es) may replace or may be added to these three processes.

If the CPU 52 determines that the initial-setting completion flag is 1 (S10: YES), the CPU 52 proceeds to S30 (see FIG. 2B). The CPU 52 controls the LCD 58 to display a home screen 130 (S30). The home screen will be described further below. On the other hand, if the initial-setting completion flag is zero (S10: NO), the CPU 52 determines whether a second-screen displayed-before flag is set to 1 (S12). The second-screen displayed-before flag is set to 1 when a second screen is displayed on the LCD 58, and an initial value thereof is 0 (zero). The second screen is described further below with reference to S18.

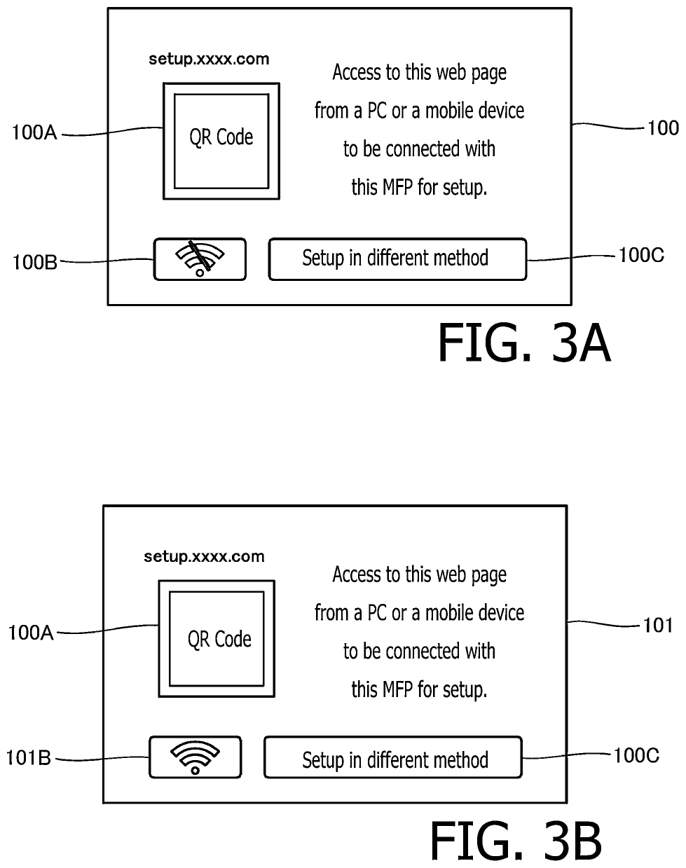

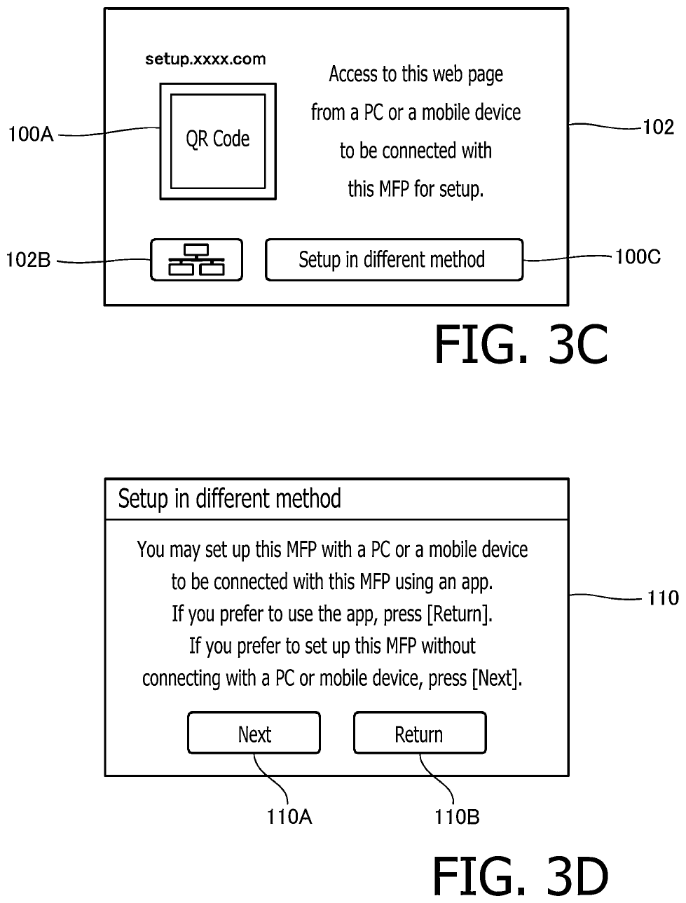

If the CPU 52 determines that the second-screen displayed-before flag is zero (S12: NO), the CPU 52 controls the LCD 58 to display a first screen (S14), which is one of first screens 100-102 as shown in FIGS. 3A-3C. Displaying one of the first screens 100-102 is an example of the first notification. The LCD 58 is an example of the notifying device.

The first screen 100 shown in FIG. 3A includes a QR Code 100A, a Wi-Fi icon 100B, and a setup-in-different-method button 100C. QR Code is a registered trademark of DENSO WAVE INCORPORATED. At a position above the QR Code 100A, an address (e.g., setup.xxx.com) that the QR Code 100A indicates, is displayed in text. Moreover, at a rightward position with respect to the QR Code 100A, an instruction for setting up the mobile terminal 10 using the first screen 100 is explained. The Wi-Fi icon 100B in the first screen 100 expresses that the MFP 50 is not connected wirelessly to the network 200 through the network IF 56.

The first screen 101 shown in FIG. 3B differs from the first screen 100 shown in FIG. 3A in an appearance of the Wi-Fi icon 101B. Therefore, items included in the first screen 101 shown in FIG. 3B that are substantially equal to those in the first screen 100 in FIG. 3A are referred to by the same reference signs, and explanation of those is herein omitted. The Wi-Fi icon 101B expresses that MFP 50 is connected wirelessly to the network 200 though the network IF 56. If the user touches the Wi-Fi icon 100B in the first screen 100 (FIG. 3A), the first screen 100 shifts to a Wi-Fi setting screen (not shown), and the user may set up the Wi-Fi connection with the MFP 50 in a known method. When the Wi-Fi setting is completed, the CPU 52 may control the LCD 58 to display the first screen 101 shown in FIG. 3B, in which the Wi-Fi icon 100B is replaced with the Wi-Fi icon 101B. Optionally, as the user touches the Wi-Fi icon 101B, and the first screen 101 shifts to the Wi-Fi setting screen (not shown), the user may select another access point in a known procedure and set up the Wi-Fi connection with the selected access point.

The first screen 102 shown in FIG. 3C differs from the first screen 100 shown in FIG. 3A in that the first screen 102 includes a wired LAN icon 102B in place of the Wi-Fi icon 100B. Therefore, items included in the first screen 102 shown in FIG. 3C that are substantially equal to those in the first screen 100 in FIG. 3A are referred to by the same reference signs, and explanation of those is herein omitted. The wired LAN icon 102B expresses that the MFP 50 is connected to the network 200 via a wired connection through the network IF 56. When the user connects a LAN cable (not shown) to a wired LAN port (not shown) of the network IF 56, the first screen 100 shown in FIG. 3A shifts to the first screen 102 shown in FIG. 3C. In other words, the Wi-Fi icon 100B is replaced with the wired LAN icon 102B. The user may connect the wired LAN cable to the MFP 50 while the first screen 101 shown in FIG. 3B is being displayed. In such a case, the first screen 101 as shown in FIG. 3B may shift to the first screen 102 shown in FIG. 3C likewise. In other words, the communication setting may prioritize the wired LAN communication, but the setting may be switched optionally from the wired LAN communication to the Wi-Fi-based wireless communication. For example, the user may touch the wired LAN icon 102B in the first screen 102, and the first screen 102 may shift to the Wi-Fi setting screen (not shown). The user may set up the Wi-Fi connection with the MFP 50 in a known method. When the Wi-Fi setting is completed, the first screen 102 shown in FIG. 3C shifts to the first screen 101 shown in FIG. 3B.

While one of the first screens 100-102 is being displayed, the user may capture the image of the QR Code 100A with a camera in the mobile terminal 10. In response, the CPU 12 in the mobile terminal 10 analyzes the captured QR Code 100A and accesses to the address (setup.xxxx.com) included in the QR Code 100A with the network I/F 16. Further, the CPU 12 downloads and installs the initial-setting application 30, by which the CPU 12 is enabled to execute the initial-setting process for the MFP 50, from the service-providing server 70. In a case where the mobile terminal 10 is not capable of analyzing the QR Code 100A, in a reason such that, for example, the mobile terminal 10 is not equipped with a camera to capture the QR Code 100A, the user may input the address in text through the touch panel 22, and the mobile terminal 10 may access the designated address, download the initial-setting application 30 from the service-providing server 70, and install the downloaded initial-setting application 30.

The QR Code 100A is an example of the code information. The Wi-Fi icons 100B, 101B, and the wired LAN icon 102 are examples of the object for causing the controller to shift to a communication setting. The setup-in-different-method button 100C is an example of the object for enabling the controller to receive a request for executing the initial-setting process without using the external terminal.

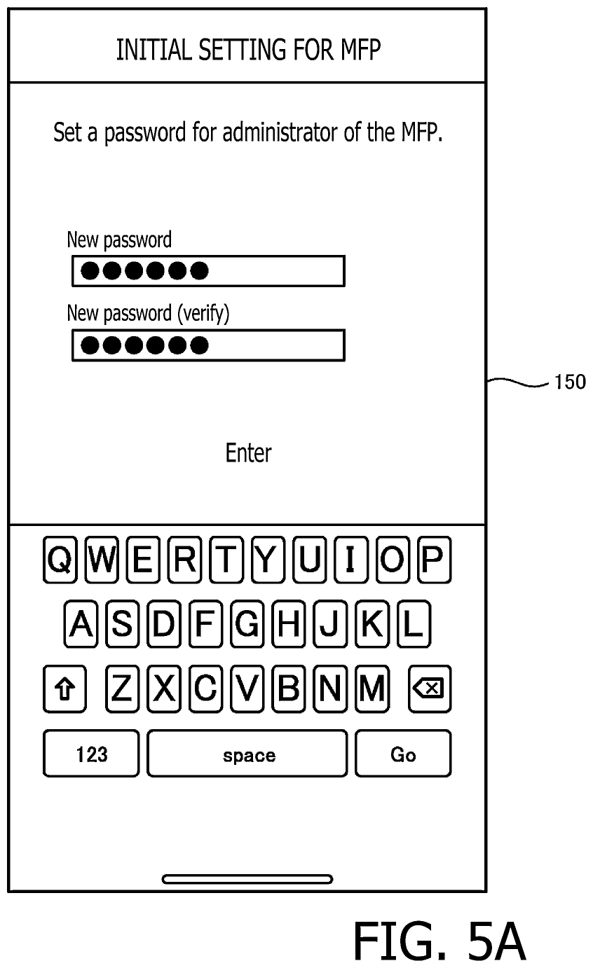

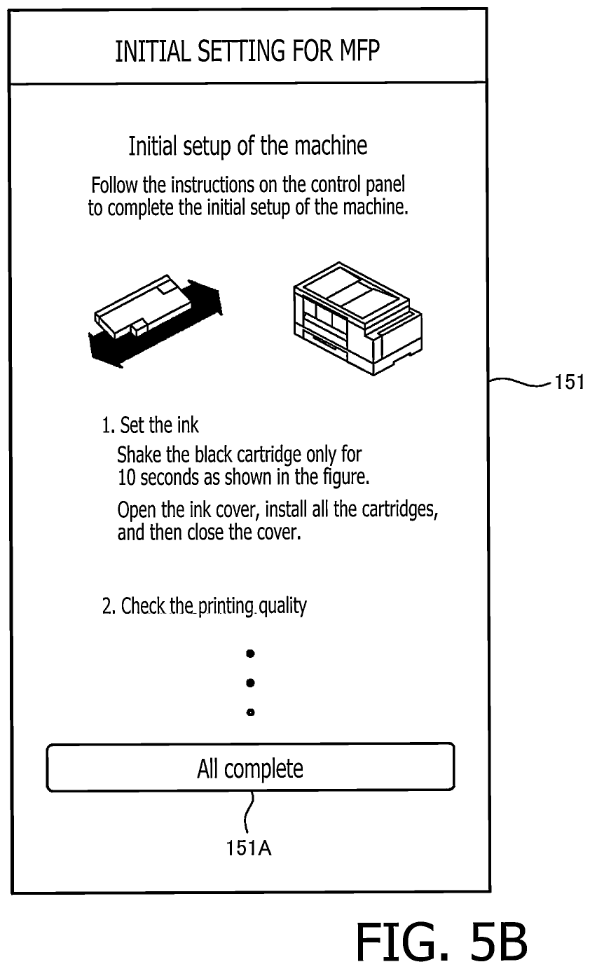

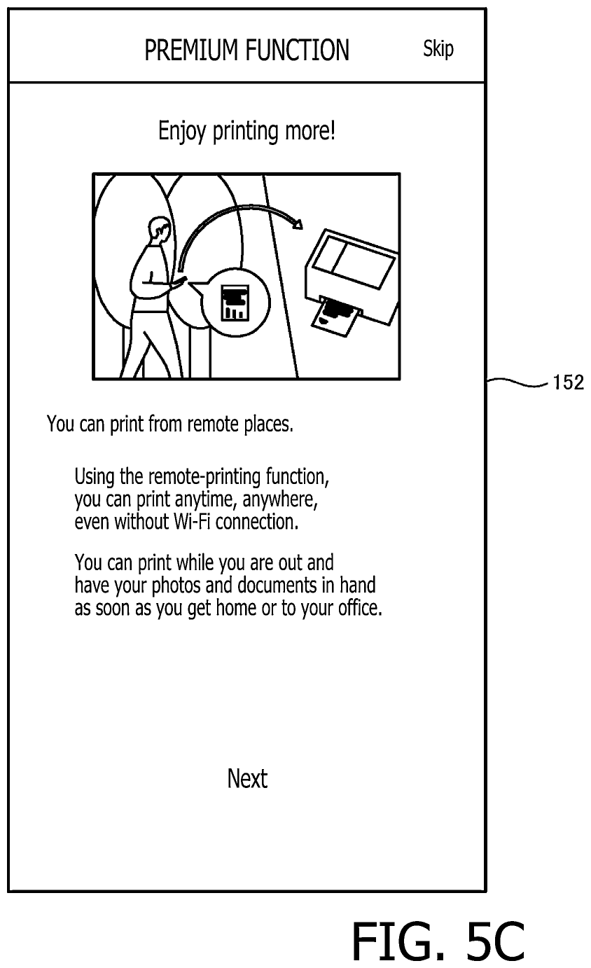

As the initial-setting application 30 is installed in the mobile terminal 10 and the user instructs the mobile terminal 10 to activate the initial-setting application 30, the initial-setting application 30 activates. Through the initial-setting application 30, the user may select the MFP 50 among other devices, if any, connected to the network 200. If the initial settings of the MFP 50 are incomplete by the time when the user selects the MFP 50, the initial settings may be completed in cooperation with the initial-setting application 30 in the mobile terminal 10. In particular, the initial-setting application 30 in the mobile terminal 10 controls the LCD 20 to display an administrator's password setting screen 150 as shown in, for example, FIG. 5A. Through the administrator's password setting screen 150, the user enters a password for the administrator, and the CPU 12 transmits the entered password to the MFP 50. The CPU 52 in the MFP 50 receives the password for the administrator through the network IF 56 and stores the received password in the data-storage area 68 in the memory 54. As such, the setting process to set the password for the administrator is executed.

Next, the initial-setting application 30 reads current time set in the mobile terminal 10 and transmits information concerning the current time to the MFP 50. The CPU 52 in the MFP 50 receives the information concerning the current time through the network I/F 56 and stores the information in the data-storage area 68 in the memory 54. As such, the setting process to set time is executed.

Next, the initial-setting application 30 controls the LCD 20 to display a setup guidance screen 151 for setting up the MFP 50 as shown in, for example, FIG. 5B and transmits a start instruction for the initial loading process to the MFP 50.

Referring back to FIG. 2A, after S14, the CPU 52 determines whether the setup-in-different-method button 100C displayed on the LCD 58 is touched (S40). If the CPU 52 determines that the setup-in-different-method button 100C is touched (S40: YES), the CPU 52 controls the LCD 58 to display a setup-in-different-method screen 110 (S42). FIG. 3D illustrates the setup-in-different-method screen 110 to be displayed on the LCD 58 in response to the touch to the setup-in-different-method button 100C. The setup-in-different-method screen 110 guides a method for setting up the MFP 50 using the input I/F 60 of the MFP 50 rather than executing the initial-setting process using the mobile terminal 10. The setup-in-different method screen 110 includes a next button 110A and a return button 110B and displays text explaining in what cases the user may press the next button 110A or the return button 110B.

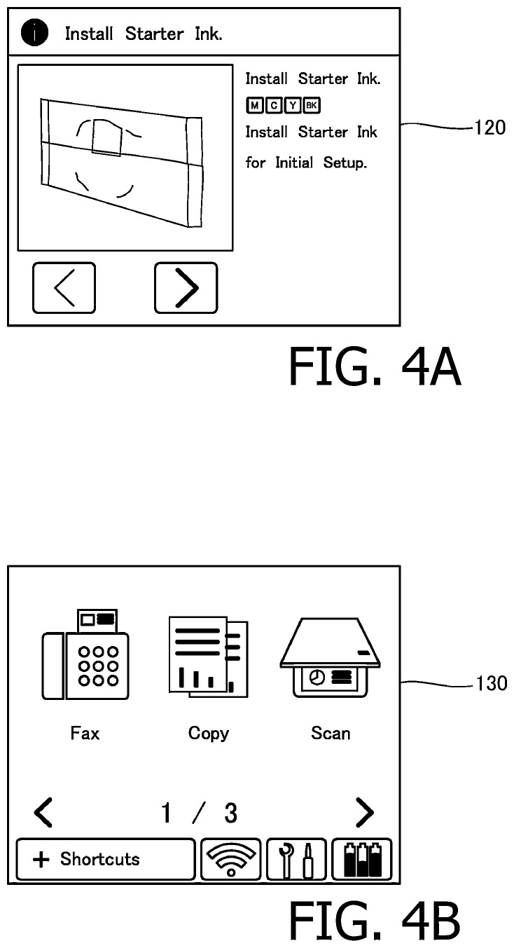

Referring back to FIG. 2A, if the CPU 52 determines that the setup-in-different-method button 100C is not touched (S40: NO), the CPU 52 waits until the start instruction for the initial loading process is received (S16: NO). If the CPU 52 receives the start instruction for the initial loading process (S16: YES), the CPU 52 controls the LCD 58 to display a second screen 120. FIG. 4A illustrates the second screen 120, which is an example of the second screen, guiding the user to attach a starter cartridge to the MFP 50. Thereafter, the CPU 52 sets the second-screen displayed-before flag to 1 (S20). Displaying the second screen 120 is an example of the second notification. Optionally, if the MFP 50 is equipped with a tank in place of the cartridge compartment 65, the second screen 120 may guide the user to load the tank with a corresponding colorant.

Next, the CPU 52 proceeds to S22 (See FIG. 2B) and determines whether the cartridge is attached to the MFP 50 based on a detection result from the detection sensor provided in the cartridge compartment 65 (S22). In the case where the MFP 50 is equipped with the tank in place of the cartridge compartment 65, the CPU 52 may determine whether the tank is loaded with a predetermined threshold amount or a larger amount of the corresponding colorant. If the CPU 52 determines that the cartridge is not attached to the MFP 50 (S22: NO), the CPU 52 repeats S22 (S22). If the CPU 52 determines that the cartridge is attached to the MFP 50 (S22: YES), the CPU 52 executes the initial loading process (S24) and controls the LCD 58 to display a screen indicating that the initial loading process is in progress. The initial loading process may include a process to agitate the toner contained in the cartridge, in the case where, for example, the printer 61 is an electro-photographic printer. For another example, in the case where the printer 61 is an inkjet printer, the initial loading process may include a process to supply the ink from the cartridge to the inkjet head. For another example, the initial loading process may include a process to correct a printing position on a printing medium and a test-printing process. The CPU 52 continues the initial loading process until the initial loading process is completed (S26: NO). When the initial loading process is completed (S26: YES), the CPU 52 sets the initial-setting completion flag to 1 (S28), controls the LCD 58 to display the home screen 130 (S30), and thereafter, ends the powered-supply on process. FIG. 4B illustrates an example of the home screen 130. The home screen 130 includes icons to activate functions provided to the MFP 50, such as facsimile transmission, copying, and scanning. The home screen 130 further includes an icon indicating remaining amounts of the colorants and a setting icon.

Meanwhile, in S44, the CPU 52 determines whether the next button 110A in the setup-in-different-method screen 110 displayed in S42 is touched (S44). If the CPU 52 determines that the next button 110A is touched (S44: YES), the CPU 52 determines that the start instruction for the initial loading process is received (S16: YES). On the other hand, if the CPU 52 determines that the return button 110B is touched (S44: NO), the CPU 52 returns to S14 and controls the LCD 58 to display one of the first screens 100-102.

In S12, if the second-screen displayed-before flag is 1 (S12: YES), the CPU 52 controls the LCD 58 to display the second screen 120 (S32) and thereafter proceeds to S22. In the case where the CPU 52 proceeds to S32, it may be understood that the initial-setting process is incomplete but the second screen 120 had been displayed earlier before the powered-on process started. In other words, after the initial-setting application 30 in the mobile terminal 10 displayed the setup guidance screen 151, the power supply to the MFP 50 was discontinued, and thereafter the power supply to the MFP 50 was resumed. In this case, the CPU 52 controls the LCD 58 to display the second screen 120 rather than one of the first screens 100-102.

Thereafter, when an all-complete button 151A in the setup guidance screen 151 as shown in FIG. 5B is pressed, the initial-setting application 30 in the mobile terminal 10 transmits an inquiry to the MFP 50 whether the initial-setting process is completed. In response, the CPU 52 of the MFP 50 may transmit a reply indicating that the initial-setting process is completed. If the mobile terminal 10 receives the reply from the MFP 50, the initial-setting application 30 in the mobile terminal 10 controls the LCD 20 to display a user-service providing screen 152 as shown in, for example, FIG. 5C. The user-service notifying screen 152 may include a message to inform the user of a remote-printing function and a next button. If the user selects the next button in the user-service notifying screen 152, the LCD 20 may display a home screen, which is not shown, including the icons through which the functions provided to the MFP 50 are available. Optionally, the selection of the next button by the user may direct the user to a process, through which the user may subscribe to the remote-printing service.

As described above, the MFP 50 in the present embodiment includes the network I/F 56, the LCD 58, the input I/F 60, and the CPU 52. The CPU 52 is configured to, in response to the instruction for power supply input through the input I/F 60, execute a determining process (S10), in which the CPU 52 determines whether the initial-setting process in the MFP 50 is completed. If the CPU 52 determines that the initial-setting process is incomplete, the CPU 52 is configured to execute a first-screen display process (S14), in which the CPU 52 controls the LCD 58 to display one of the first screens 100-102, which prompts execution of the initial-setting process in the MFP 50 using the mobile terminal 10.

As such, the MFP 50 according to the present embodiment performs, in the case where the initial-setting process is incomplete, the first-screen displaying process, which guides the user to the initial-setting process using the mobile terminal 10. Thereby, the user who instructed power supply to the MFP 50 may be informed of the procedure to follow. Accordingly, the initial-setting process to set up the MFP 50 may be performed easily using the mobile terminal 10.

Moreover, if the CPU 52 receives the start instruction for the initial loading process from the mobile terminal 10 through the network I/F 56 (S16) after one of the first screens 100-102 is displayed on the LCD 58, the CPU 52 executes the initial loading process in the MFP 50. The initial loading process is an example of the initial-setting process. As such, the MFP 50 may perform the initial-setting process in response to receiving the instruction from the mobile terminal 10 following the guidance of one of the first screens 100-102.

Moreover, if the CPU 52 receives the start instruction for the initial loading process from the mobile terminal 10 through the network I/F 56 while the LCD 58 is displaying a screen different from the first screens 100-102, the CPU 52 does not execute the initial loading process in the MFP 50. According to the present embodiment, the start instruction for the initial loading process is ignored when a screen other than any one of the first screens 100-102 is being displayed.

If the start instruction for the initial loading process is received from the mobile terminal 10 even though one of the first screens 100-102 is not being displayed, it may be considered an error such that the user of the mobile terminal 10 erroneously selected the MFP 50 as an addressee of the start instruction for the initial loading process, and the mobile terminal 10 transmitted the instruction to the MFP 50 rather than a different communication apparatus. In such an occasion, the CPU 52 is prevented from executing the initial loading process in the MFP 50 in response to the erroneously received start instruction for the initial loading process. In other words, the initial loading process is prevented from being executed erroneously.

Moreover, if the CPU 52 receives the start instruction for the initial loading process after one of the first screens 100-102 is displayed on the LCD 58, the CPU 52 executes a second-screen displaying process (S18), in which the CPU 52 controls the LCD 58 to display the second screen 120 showing the procedure to follow for executing the initial loading process. Accordingly, the user may be informed of the necessary procedure to follow for executing the initial loading process.

Moreover, when the second screen 120 is displayed on the LCD 58 (S18-S20, S32), the CPU 52 does not control the LCD 58 to display any one of the first screens 100-102 (S22-S30). The condition the second screen 120 was displayed on the LCD 58 in the past may mean that the CPU 52 has already received the start instruction for the initial loading process. Therefore, if one of the first screens 100-102 is displayed again, the CPU 52 may receive another start instruction for the initial loading process. In this regard, according to the present embodiment, once the CPU 52 receives the start instruction for the initial loading process, the first screens 100-120 are prevented from being displayed. Therefore, once the start instruction for the initial loading process is received, receiving of another start instruction for the same initial loading process is prevented. In other words, the initial loading process is prevented from being executed redundantly.

Moreover, if the CPU 52 receives the start instruction for the initial loading process from the mobile terminal 10 through the network I/F 56 after the second screen 120 is displayed on the LCD 58 (S18-S20, S32), the second screen 120 is not displayed again on the LCD 58 of the MFP 50 in reply to the instruction (S12: YES). The condition the second screen 120 was displayed on the LCD 58 in the past may mean that the initial loading process is in progress or is completed. Therefore, if the second screen 120 is displayed again in response to receiving of the start instruction for the initial loading process under this condition, the initial loading process may be executed redundantly. In this regard, according to the present embodiment, the start instruction for the initial-setting process is receivable while one of the first screens 100-102 is being displayed (S14, S16), and the second screen 120 may be displayed thereafter. Once the second screen 120 is displayed, the instruction may be received thereafter but is ignored. Accordingly, the initial loading process may be prevented from being executed redundantly.

Moreover, the MFP 50 has the LCD 58, and the CPU 52 may control the LCD 58 to display the address, e.g., setup. xxxx.com, being the location to be accessed by the mobile terminal 10 to download a transmitting program, i.e., the initial-setting application 30, for transmitting the start instruction for the initial loading process to the MFP 50, in a first-screen displaying process. Therefore, the user may access the location taught in the LCD 58 with the mobile terminal 10 and download the transmitting program in the mobile terminal 10.

Moreover, the CPU 52 may control the LCD 58 to display code information readable by the mobile terminal 10, i.e., the QR Code 100A including the location to be accessed, in the first-screen displaying process. Accordingly, the user may access the location contained in the QR Code 100A without inputting the location manually and download the transmitting program.

Moreover, the MFP 50 has the LCD 58, and the CPU 52 may control the LCD 58 to display the icon 100B, 101B, or 102B, through which the CPU 52 may shift from the first-screen displaying process to a setting process to set up the communication through the network I/F 56. For enabling the MFP 50 to receive the start instruction for the initial loading process from the mobile terminal 10, the communication setting to connect the MFP 50 and the mobile terminal 10 is necessary. In this regard, according to the present embodiment, the CPU 52 may shift from the first-displaying process to the setting process to set up the communication through the network I/F 56 with the touch on the icon 100B, 101B, or 102B by the user easily and conveniently.

Moreover, the MFP 50 has the LCD 58, and the CPU 52 may control the LCD 58 to display one of the first screens 100-102 on the LCD 58 and thereafter display the setup-in-different-method button 100C, through which the CPU 52 may receive a request from the user to execute the initial-setting process without using the mobile terminal 10. Thereby, the CPU 52 may execute the initial-setting process in a different method, in which the mobile terminal 10 is not used.

Next, more examples of the first notification, the second notification, the object for causing the controller to shift to the communication setting, the object for enabling the controller to receive a request for executing the initial-setting process without using the external terminal will be explained.

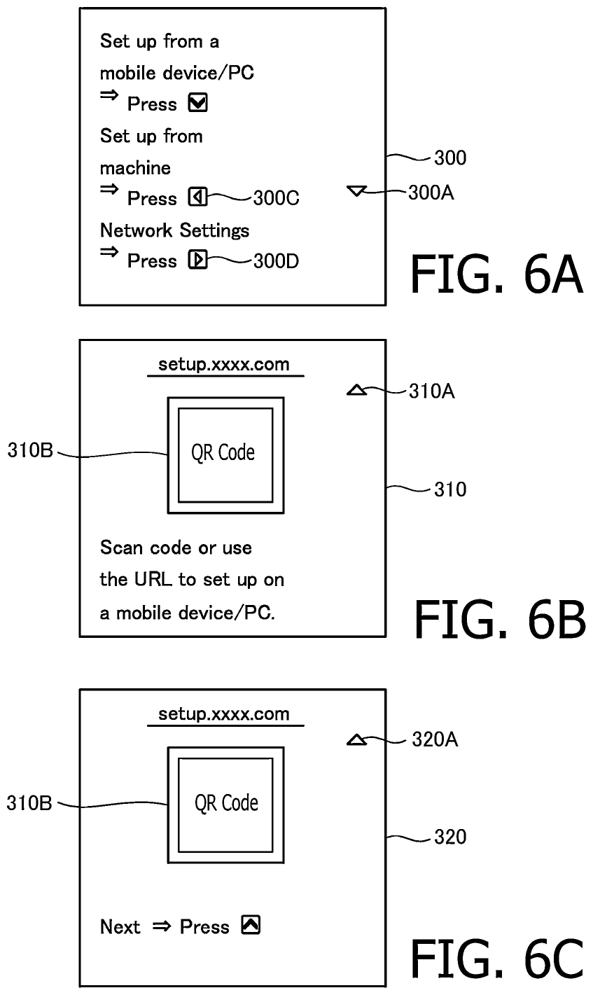

FIGS. 6A-6C illustrate first screens 300, 310, 320 in formats different from the first screens 100, 101, 102 to be displayed in an LCD of the MFP 50, which is not equipped with the touch panel but has the displaying function alone. The first screens 300, 310, 320 are another example of the first notification.

The MFP 50 may have a hardware key (not shown) associated with a displayed button 300C included in the first screen 300 as shown in FIG. 6A. The user may press the hardware key to cause the first screen 300 on the LCD to shift to a screen (not shown), through which the communication may be set in a different method. As such, the displayed button 300C is another example of the object for enabling the controller to receive the request to execute the initial-setting process without using the external terminal. Meanwhile, pressing the hardware key associated with the displayed button 300D in the first screen 300 may cause the first screen 300 on the LCD to shift to the screen (not shown), through which the communication may be set up; therefore, the displayed button 300D is another example of the object for causing the controller to shift to the communication setting.

A QR Code 310B included in the first screens 310, 320 may be substantially the same as the QR Code 100A included in the first screens 100-102 shown in FIGS. 3A-3C.

The first screen 300 on the LCD may shift to the first screen 310 by the user pressing a hardware key (not shown) associated with a button 300A in a form of a downward triangle. Moreover, the screen may toggle between the first screen 310 and the first screen 320 in, for example, every 2 seconds. Furthermore, the first screen 310 may shift to the first screen 300 by the user pressing a hardware key (not shown) associated with a button 310A in a form of an upward triangle, and the first screen 320 may shift to the first screen 300 by the user pressing a hardware key (not shown) associated with a button 320A in a form of an upward triangle.

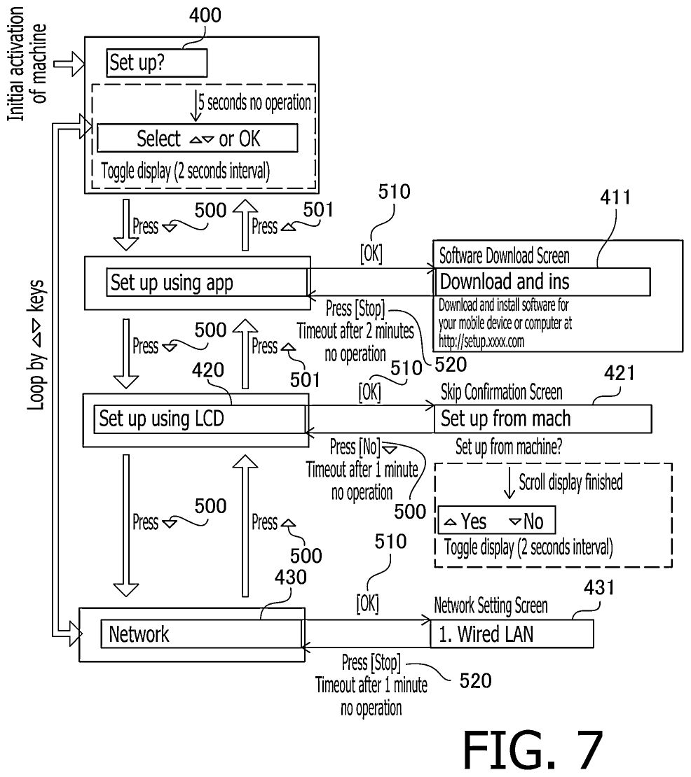

FIG. 7 illustrates screens to be displayed on the LCD 58, in a case where the LCD 58 is configured to display text in a single line. A first screen 411 shown in FIG. 7 is another example of the first notification. In the first screen 411, a text string “Download and install software for your mobile device or computer at http://setup.xxxx.com” as shown in a frame enclosing the first screen 411 may be scrolled. The LCD 58 may display the first screen 411 by shifting from a setting screen 400 to a selection screen 410, linked with the first screen 411, by the user pressing a hardware key 500 in a form of, for example, a downward triangle, and further shifting from the selection screen 410 by the user pressing a hardware OK key 510. The screen may shift from the first screen 411 to the selection screen 410 by the user pressing a hardware Stop key 520 or by causing the MFP 50 to timeout without operating any key or button for, for example, two minutes. On the other hand, the screen may shift from the selection screen 410 to the setting screen 400 by the user pressing a hardware key 501 in a form of, for example, an upward triangle.

A screen 420 is another example of the object for enabling the controller to receive the request to execute the initial-setting process without using the external terminal. The screen 420 may shift to a screen 421, through which the initial-setting process without using the external terminal may be executed. The LCD 58 may display the screen 420 by shifting from the setting screen 400 to the selection screen 410 linked with the first screen 411 by the user pressing the hardware key 500, and further shifting from the selection screen 410 by the user pressing the hardware key 500. The screen 420 may shift to the selection screen 410 by the user pressing the hardware OK key 510. On the other hand, the screen 421 may shift to the screen 420 by the user pressing the hardware key 500 or by causing the MFP 50 to timeout without operating any key or button for, for example, one minute.

A screen 430 is another example of the object for causing the controller to shift to the communication setting. The screen 430 may shift to a screen 431, through which the CPU 52 may enter a communication setting mode. The setting screen 400 may shift to the screen 420 by shifting to the selection screen 410 linked with the first screen 411 by the user pressing the hardware key 500, further shifting from the selection screen 410 to the selection screen 420 by the user pressing the hardware key 500, and further shifting from the selection screen 420 by the user pressing the hardware key 500. The screen 430 may shift to a screen 431 by the user pressing the hardware OK key 510. On the other hand, the screen 431 may shift to the screen 430 by the user pressing the hardware Stop key 520 or by causing the MFP 50 to timeout without operating any key or button for, for example, one minute.

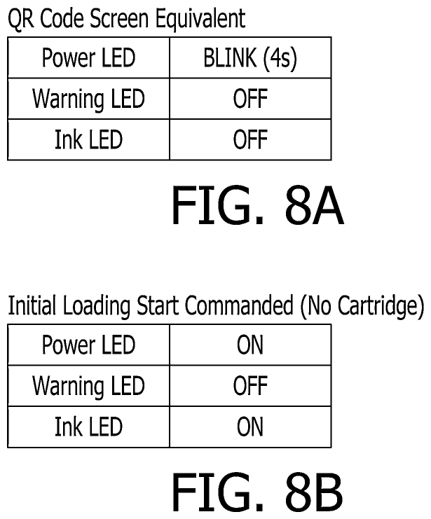

FIGS. 8A-8B illustrate combinations of lighting patterns of a display device consisting of LEDs alone. As shown in FIGS. 8A-8B, the LEDs include a power LED, a warning LED, and an ink LED. The power LED indicates the power status of the MFP 50. The warning LED indicates a warning or an error that requires attention. The ink LED indicates the level of the ink stored in the cartridge attached to the cartridge compartment 65. According to the combination of the lighting patterns shown in FIG. 8A, the power LED is controlled to blink at an interval of four seconds, the warning LED is turned off, and the ink LED is turned off. The combination of the lighting patterns as shown in FIG. 8A may correspond to the first screen and is another example of the first notification. The LEDs in this combination of the lighting patterns may indicate that the MFP 50 is awaiting the start instruction for the initial loading process in S16. According to the combination of the lighting patterns shown in FIG. 8B, the power LED is turned off, the warning LED is turned off, and the ink LED is turned on. The combination of the lighting patterns as shown in FIG. 8B may correspond to the second screen and is another example of the second notification. While the LEDs are in the combination of the lighting patterns as shown in FIG. 8A, and when the start instruction for the initial loading process is received from the mobile terminal 10, the combination of the lighting patterns as shown in FIG. 8A may shift to the combination as shown in FIG. 8B. Optionally, the CPU 52 may determine, when the user presses a specific hardware key while the LEDs are in the combination of the lighting patterns as shown in FIG. 8A, that the request to execute the initial-setting process without using the external terminal is received and control the LEDs to the lighting patterns as shown in FIG. 8B.

While the present disclosure has been described in conjunction with an example structure outlined above and illustrated in the figures, various alternatives, modifications, variations, improvements, and/or substantial equivalents, whether known or that may be presently unforeseen, may become apparent to those having at least ordinary skill in the art. Accordingly, the example embodiment of the disclosure, as set forth above, is intended to be illustrative of the invention, and not limiting the invention. Various changes may be made without departing from the spirit and scope of the disclosure. Therefore, the present disclosure is intended to embrace all known or later developed alternatives, modifications, variations, improvements, and/or substantial equivalents.

For example, the communication apparatus according to the present disclosure may not necessarily be limited to the MFP 50 but may be, for example, a single-functioned copier capable of communication.

For another example, the controller according to the present disclosure may not necessarily be limited to the single CPU 52, but the controller may consist of a plurality of CPUs or may include a CPU consisting of a plurality of cores.

For another example, the code information according to the present disclosure may not necessarily be limited to the QR Code but may be, for example, two-dimensional code, one-dimensional code, or a three-dimensional code.

For another example, the initial-setting process according to the present disclosure may not necessarily be limited to the initial loading process but may include any process that involves initial settings of the communication apparatus.

For another example, the flows of the steps in the powered-on process may not necessarily be limited to those in the flowchart shown in FIGS. 2A-2B. For example, after receiving the start instruction for the initial loading process (S16), the second screen may not necessarily be displayed (S18), or the CPU 52 may not necessarily determine that the cartridge is attached to the cartridge compartment 65 (S22: YES) before executing the initial loading process (S24). For example, in response to receiving of the start instruction for the initial loading process (S16: YES), the CPU 52 may execute the initial loading process, omitting the step to display the second screen (S18) and the step to determine whether the cartridge is attached to the cartridge compartment 65 (S22).

What is claimed is:

1. A communication apparatus, comprising:
a communication interface;
a notifying device; and
a controller configured to:
in response to power supply to the communication apparatus, determine whether an initial-setting process in the communication apparatus is completed; and
in response to determining that the initial-setting process is incomplete, control the notifying device to perform a first notification that prompts execution of the initial-setting process using an external terminal.

2. The communication apparatus according to claim 1, wherein the controller is configured to, in response to receiving a start instruction for the initial-setting process from the external terminal through the communication interface after the execution of the first notification, execute the initial-setting process.

3. The communication apparatus according to claim 1, wherein the controller is configured, when the notifying device performs a notification that is different from the first notification not to execute the initial-setting process.

4. The communication apparatus according to claim 1, wherein the controller is configured to in response to receiving a start instruction for the initial-setting process from the external terminal through the communication interface after the execution of the first notification, control the notifying device to perform a second notification, the second notification indicating a necessary procedure to follow for executing the initial-setting process.

5. The communication apparatus according to claim 4, wherein the controller is configured, when the notifying device performs the second notification, not to control the notifying device to perform the first notification.

6. The communication apparatus according to claim 4, wherein the controller is configured, in response to receiving the start instruction for the initial-setting process from the external terminal through the communication interface after the execution of the first notification, not to repeat the second notification.

7. The communication apparatus according to claim 1, further comprising a display,
wherein the controller is configured to control the display to display, as the first notification, a location to be accessed by the external terminal in order to download a transmitting program for transmitting the start instruction for the initial-setting process to the communication apparatus.

8. The communication apparatus according to claim 7, wherein the controller is configured to control the display to display, as the first notification, code information readable by the external terminal, the code information including the location.

9. The communication apparatus according to claim 1, further comprising a display,
wherein the controller is configured to control the display to display, as the first notification, an object for causing the controller to shift to a communication setting using the communication interface.

10. The communication apparatus according to claim 1, further comprising a display,
wherein the controller is configured to, in response to the notifying device executing the first notification, control the display to display an object for enabling the controller to receive a request for executing the initial-setting process without using the external terminal.
